(19) United States
(12) Patent Application Publication
(10) Pub. No.: US 2020/0202192 A1
(43) Pub. Date: Jun. 25, 2020

(54) ATTACHED-TYPE SMART LABEL

(71) Applicant: Shenzhen Leadercolor Smart Card Co., Ltd, Shenzhen City (CN)

(72) Inventor: Wenchang HU, Shenzhen City (CN)

(73) Assignee: Shenzhen Leadercolor Smart Card Co., Ltd, Shenzhen City (CN)

(21) Appl. No.: 16/227,415

(22) Filed: Dec. 20, 2018

(51) Int. Cl. G06K 19/077; G06K 19/06

(52) U.S. Cl. CPC G06K 19/07722; G06K 19/06037; G06K 19/06028

(57) ABSTRACT

The present invention discloses an attached-type smart label, where the smart label is a strip sheet including a protective layer formed by flexible plastic paper, an RFID chip layer, a support layer formed by flexible plastic paper, an adhesive layer formed by a base material containing double-sided adhesive film, and a release film layer; the protective layer and the support layer are attached to two sides of the RFID chip layer, respectively; one surface of the adhesive layer is covered with the release film layer, and the other surface of the adhesive layer is attached to one surface, facing away from the RFID chip layer, of the protective layer or the support layer; and the RFID chip layer includes an antenna and an RFID chip printed and etched on a base material. The RFID smart label in the present invention not only can protect the RFID chip and the antenna from being corroded and oxidized by air, water, gasoline, and other chemical products, but also can be firmly attached to an article such as automobile glass by using a base material containing double-sided adhesive.

### TECHNICAL FIELD

The present invention belongs to the smart label fabrication field, and in particular, to an attached-type smart label.

### BACKGROUND

RFID (Radio Frequency Identification) technology is a non-contact automatic identification technology. The technology is often utilized in electronic labels. In this technology, a target object is automatically identified by using a radio-frequency signal; relevant data is obtained, an identification system does not need to establish mechanical or optical contact with a specific target, and manual intervention is not required during an identification operation.

A smart card (Smart Card) is a plastic card (usually credit card-sized) embedded with a microchip, and generally includes an antenna, an RFID chip, and a corresponding equivalent resistor. Because the smart card includes a RFID chip, the smart card can identify a cardholder without any physical contact with a reader/writer. The reader/writer externally transmits a radio frequency signal of a specific frequency that includes information. After the RFID smart card enters a magnetic field, the radio frequency signal transmitted from the reader/writer is received by using the antenna, sufficient energy is obtained via an induction current, the RFID smart card is activated, and an internal circuit of the RFID smart card returns, according to a specific instruction of the reader/writer, corresponding information stored in an integrated circuit chip.

Chinese Patent Application No. 201320055519.0 discloses a self-luminous RFID smart card. A light emitting diode is disposed in a smart card to form a light emitting unit, so that a cardholder can identify a communication status of the self-luminous RFID smart card. Chinese Patent Application No. 201520473437.7 also discloses an RFID smart card. The smart card includes a plastic card and an RFID chip and an antenna that are embedded in the plastic card. This application further discloses that a bearing layer of the RFID chip and an outer layer of a bearing layer of the antenna each are bonded with a waterproof plastic layer through glue filling. The smart cards disclosed in the above patent applications are all handheld smart cards, which is not conducive to rapid identification of a user's identity. In addition, in the existing technologies, only simple waterproofing is carried out on the smart cards, and the RFID chip and the antenna are prone to be corroded and oxidized by air, water, gasoline, and other chemical products, resulting in rapid aging and damage of the RFID chip and the antenna.

### SUMMARY

To overcome the disadvantages of the prior art, the present invention provides a portable attached-type or attachable smart label that can be attached to automotive glass or other articles, where an RFID chip and an antenna are well protected through superimposition of multiple film layers, so as to prolong a service cycle of the RFID smart label.

An objective of the present invention is achieved according to the following technical solution.

An attached-type smart label is provided, wherein: the smart label comprises a strip sheet preferably including one or more protective layers formed by flexible plastic paper, an RFID chip layer, a support layer formed by flexible plastic paper, an adhesive layer formed by a base material containing double-sided adhesive film, and a release film layer; a base material of a base material-containing double-sided adhesive is one of cotton paper, PET (polyethylene terephthalate), PVC (polyvinyl chloride) film, non-woven fabric, foam, and acrylic foam, and an adhesive such as elastomeric pressure-sensitive adhesive, resin pressure-sensitive adhesive, or acrylic pressure-sensitive adhesive is uniformly coated on a surface of the base material; the support layer and the protective layer each may be one of a polyethylene (PE) film, a polypropylene (PP) film, a polystyrene (PS) film, a polymethyl methacrylate (PMMA, commonly known as Plexiglas®) film, a polyvinyl chloride (PVC) film, a polyamide (Nylon) film, a polycarbonate (PC) film, a polyurethane (PU) film, a polytetrafluoroethylene (PTFE, commonly known as Teflon®) film, a polyethylene terephthalate (PET) film, an acrylonitrile-butadiene-styrene (ABS) copolymer film, or another flexible plastic paper with similar performance.

The protective layer and the support layer are attached to two sides of the RFID chip layer, respectively; one surface of the adhesive layer is covered with the release film layer, and the other surface of the adhesive layer is attached to a surface, facing away from the RFID chip layer, of the protective layer or the support layer.

The RFID chip layer includes an antenna and an RFID chip printed and etched on the base material.

In an implementation solution of the present invention, a coating provided with a pattern and/or a barcode is arranged on the support layer or the protective layer, and a surface, on which the pattern and/or the barcode is arranged, of the support layer or the protective layer faces away from the RFID chip layer, and the barcode is a 1-dimensional barcode or a Quick Response (QR) code, or a combination thereof.

In a preferred embodiment of the present invention, a surface of the coating provided with a pattern and/or a barcode is covered by a flexible plastic paper protective film. The flexible plastic paper protective film can be one of a polyethylene (PE) film, a polypropylene (PP) film, a polystyrene (PS) film, a polymethyl methacrylate (PMMA, commonly known as Plexiglas®) film, a polyvinyl chloride (PVC) film, a polyamide (Nylon) film, a polycarbonate (PC) film, a polyurethane (PU) film, a polytetrafluoroethylene (PTFE, commonly known as Teflon®) film, a polyethylene terephthalate (PET) film, and an acrylonitrile-butadiene-styrene (ABS) copolymer film, or another flexible plastic paper with similar performance.

In a preferred embodiment of the present invention, the shape of the smart label is a quadrilateral, a rounded quadrilateral, or an oval.

In a preferred embodiment of the present invention, the smart label is provided with an anti-theft cut; the anti-theft cut penetrates through the protective layer, the RFID chip layer, and the support layer; the anti-theft cut includes cuts extending from four corners and/or edges of the smart label to the center of the smart label; and the cut is not in contact with the antenna and the chip structure of the RFID chip layer.

In a preferred embodiment of the present invention, the anti-theft cut includes oblique cuts arranged at the four corners and cuts arranged in the middle of two long sides of the smart label, and the cuts arranged in the middle of the two long sides of the smart label form two shapes like Chinese character “ [symbol] ” each formed by using two oblique cuts and one straight cut.

In a preferred embodiment of the present invention, the smart label is preferably a rectangle or a rounded rectangle with a length of about 80-150 mm and a width of about 15-40 mm.

In a preferred embodiment of the present invention, the smart label is more preferably a rectangle or a rounded rectangle with a length of about 90-110 mm and a width of about 18-26 mm.

In a preferred embodiment of the present invention, preferably about 6.5 mm long oblique cuts extending obliquely are arranged at four corners and edges of long sides of the smart label, and the oblique cut penetrates through the protective layer, the RFID chip layer, and the support layer.

In a preferred embodiment of the present invention, a preferably about 5 mm long straight cut perpendicular to the long side is arranged at a central edge of the long side of the smart label; the straight cut penetrates through the protective layer, the RFID chip layer, and the support layer; and a distance from a starting point of the straight cut on the long side and a starting point of the oblique cut on the long side is preferably about 11.7 mm.

Compared with the prior art, the present invention has at least the following advantages: The RFID smart label in the present invention is soft, high temperature resistant, waterproof, protects the RFID chip and the antenna from being corroded and oxidized by air, water, gasoline, and other chemical products; and the RFID smart label in the present invention can be firmly attached to an article such as automobile glass by using a base material-containing double-sided adhesive and can achieve a waterproof effect and high temperature resistance. In addition, the smart label is further provided with a pattern and a barcode, and is more convenient for payment and member management, for example, scenarios such as community access management, club member management, and parking lot access management. In addition, on the RFID smart label in the present invention, a release film is used to cover a surface, used for attachment, of the double-sided adhesive layer, to protect the adhesive effectiveness before use. Further, the present invention further provides the anti-theft cut preferably configured by using a virtual cut line, to prevent others from removing the entire smart label attached to automobile glass or other articles.

### BRIEF DESCRIPTION OF DRAWINGS

FIG. 1 is a schematic structural diagram of a preferred embodiment of an RFID smart label according to the present invention;

FIG. 2 is a schematic structural diagram of another preferred embodiment of an RFID smart label according to the present invention; and

FIG. 3 is a top perspective view of an anti-theft cut in a preferred embodiment of an RFID smart label according to the present invention.

### DETAILED DESCRIPTION

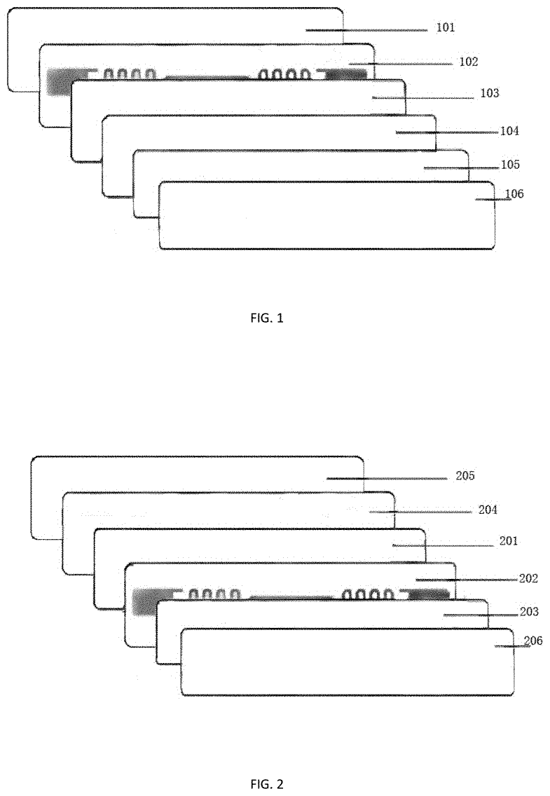

The following further describes the present invention in detail with reference to the accompanying drawings and preferred embodiments. The following preferred embodiments are only used for description and not for limitation and therefore cannot be construed as a limitation on the protective scope of the present invention. FIG. 1 shows a preferred embodiment of an attached-type smart label according to the present invention.

The smart label is a rounded rectangle and is a strip sheet including a PET film protective layer 101, an RFID chip layer 102, a support layer 103 formed by a PP film or a PVC film, a PET protective film 104 arranged on a surface, facing away from a surface of the RFID chip layer 102, of the support layer 103, an adhesive layer 105 formed by a base material-containing double-sided adhesive film, and a release film layer 106. The RFID chip layer 102 includes an antenna and an RFID chip printed and etched on a base material. As shown in FIG. 1, the PET film protective layer 101 and the support layer 103 are attached to two sides of the RFID chip layer 102, respectively; one surface of the adhesive layer 105 is covered with the release film layer 106, and the other surface of the adhesive layer 105 is attached to a surface, facing away from the RFID chip layer 102, of the support layer 103. In this embodiment, the PET protective film 104 is arranged on the surface, facing away from the surface of the RFID chip layer 102, of the support layer 103. Therefore, the adhesive layer 105 is substantially attached to a surface of the PET protective film 104 herein. In a preferred embodiment, a pattern and a barcode may be arranged on the surface of the support layer 103, and the barcode may be a 1-dimensional barcode, a QR code, or a combination thereof. During implementation, the PET protective film 104 may alternatively be omitted. However, if the PET protective film 104 is omitted, the pattern and the barcode arranged on the support layer 103 may easily to fade or fall off. As shown in FIG. 1, the adhesive layer 105 is arranged on the PET protective film 104. Therefore, a method for using the RFID smart label according to this preferred embodiment is as follows: first, the release film layer 106 is torn off to expose an adhesive of the adhesive layer 105, and then an exposed surface of the adhesive layer 105 is attached to an inner side of a vehicle window or a windshield, or may be attached to a surface of another transparent carrier. In this way, not only can the smart label be rapidly identified by using an electronic device or through automatic identification during entering or exiting from a relevant place, but also a beautification effect can be achieved.

FIG. 2 shows a preferred embodiment of another attached-type smart label according to the present invention. The smart label includes a strip sheet and a flexible strip card, where the strip sheet includes a PET film protective layer 201, an RFID chip layer 202, a support layer 203 formed by a PP film or a PVC film, an adhesive layer 204 formed by a base material containing double-sided adhesive film, and a release film layer 205; and the flexible strip card is in a shape of a rounded rectangle and includes a PET protective film 206 arranged on a surface, facing away from a surface of the RFID chip layer 202, of the support layer 203. The RFID chip layer 202 includes an antenna and an RFID chip printed and etched on a base material. As shown in FIG. 2, the PET film protective layer 201 and the support layer 203 are attached to two sides of the RFID chip layer 202, respectively; one surface of the adhesive layer 204 is covered with the release film layer 205, and the other surface of the adhesive layer 204 is attached to a surface, facing away from the RFID chip layer 202, of the PET film protective layer 201. A pattern and a barcode may further be arranged on the surface of the support layer 203, and the barcode may be a 1-dimensional barcode, a QR code, or a combination thereof. In this preferred embodiment, the PET protective film 206 is arranged on the surface, facing away from the surface of the RFID chip layer 202, of the support layer 203. During implementation, the PET protective film 206 may alternatively be omitted. However, if the PET protective film 206 is omitted, the pattern and the barcode arranged on the support layer 203 may easily fade or fall off. As shown in FIG. 2, the adhesive layer 204 is arranged on the PET film protective layer 201. Therefore, a method for using the RFID smart label according to this embodiment is as follows: first, the release film layer 205 is torn off to expose an adhesive of the adhesive layer 204; and then an exposed surface of the adhesive layer 204 is attached to an outer side of a vehicle window, a windshield, or another article. In this way, not only can the smart label be rapidly identified by using an electronic device or through automatic identification during entering or exiting from a relevant place, but also a beautification effect can be achieved.

It should be understood that, although the smart labels in FIG. 1 and FIG. 2 are both rounded rectangles, the smart label can also be implemented as other shapes, such as a quadrilateral, a rounded quadrangle, an oval or an irregular shape.

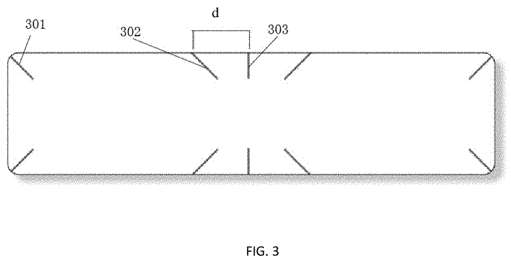

FIG. 3 shows an example of configuration of an anti-theft cut of an attached-type smart label according to a preferred embodiment of the present invention. The smart label in this preferred embodiment is provided with an anti-theft cut, the anti-theft cut penetrates through a protective layer, an RFID chip layer, and a support layer; the anti-theft cut is usually formed by multiple cuts respectively extending from four corners and/or edges of the smart label to the center of the smart label. In FIG. 3, a smart label in a shape of a rounded rectangle is used as an example for description. Multiple cuts are arranged on the smart label and include cuts 301 extending from four corners of the smart label to the center of the smart label and oblique cuts 302 and a straight cut 303 extending from an edge of a long side of the smart label to the center of the smart label. Generally, on one or two long sides, the oblique cuts 302 and the straight cut 303 form a structure in a shape like Chinese character “ [symbol] ” in a grouping manner. In this preferred embodiment, on the smart label in a shape of a rounded rectangle and with a length of 100 mm and a width of 25 mm, a distance (d) from a starting point of the oblique cut 302 on the long side and a starting point of the straight cut 303 on the long side can be 11.7 mm; lengths of a cut 301 and the oblique cut 302 can be 6.5 mm, and a length of the straight cut 303 can be 5.0 mm. In a preferred embodiment, generally, the smart label is a rectangle or a rounded rectangle with a length of 90-110 mm and a width of 18-26 mm, or may be in another shape, such as a quadrilateral, a rounded quadrangle, even an oval, or an irregular shape. However, regardless of a shape and a size of the smart label, during configuration of the anti-theft cut, the anti-theft cut cannot be in contact with a chip and an antenna of the RFID chip layer.

It should be understood that a base material of the base material containing double-sided adhesive is one of cotton paper, PET, PVC film, non-woven fabric, foam, and acrylic foam, and an adhesive such as elastomeric pressure-sensitive adhesive, resin pressure-sensitive adhesive, or acrylic pressure-sensitive adhesive is uniformly coated on a surface of the base material.

It should be understood that the support layer and the protective layer each may be one of a polyethylene (PE) film, a polypropylene (PP) film, a polystyrene (PS) film, a polymethyl methacrylate (PMMA, commonly known as Plexiglas®) film, a polyvinyl chloride (PVC) film, a polyamide (Nylon) film, a polycarbonate (PC) film, a polyurethane (PU) film, a polytetrafluoroethylene (PTFE, commonly known as Teflon®) film, a polyethylene terephthalate (PET) film, and an acrylonitrile-butadiene-styrene (ABS) copolymer film; or may be another flexible plastic paper with similar performance.

The PET protective film may also be another flexible plastic paper protective film. The flexible plastic paper protective film is one of polyethylene (PE) film, polypropylene (PP) film, polystyrene (PS) film, polymethyl methacrylate (PMMA, commonly known as Plexiglas®) film, polyvinyl chloride (PVC) film, polyamide (Nylon) film, polycarbonate (PC) film, polyurethane (PU) film, polytetrafluoroethylene (Teflon®, PTFE) film, polyethylene terephthalate (PET) film, and acrylonitrile-butadiene-styrene (ABS) copolymer film.

It should be understood that the anti-theft cut is not limited to the foregoing embodiment and may alternatively be set to another embodiment. The foregoing descriptions are merely specific preferred embodiments of the present invention, but the scope of the present invention is not limited thereto. Any modification or replacement easily figured out by any person skilled in the art without departing from the technical scope disclosed by the present invention should fall within the scope of the present invention.

Therefore, the scope of protection of the present invention shall be subjected to the scope of the claims.

### ACRONYM LIST

ABS acrylonitrile-butadiene-styrene
PC polycarbonate
PE polyethylene
PET polyethylene terephthalate
PMMA polymethyl methacrylate
PP polypropylene
PS polystyrene
PTFE polytetrafluoroethylene
PU polyurethane
PVC polyvinyl chloride
QR quick response
RFID radio frequency identification
Parts List
101 PET film protective layer
102 RFID chip layer
103 support layer
104 PET protective film
105 adhesive layer
106 release film layer
201 PET film protective layer
202 RFID chip layer
203 support layer
204 adhesive layer
205 release film layer
206 PET protective film
301 cut
302 oblique cut
303 straight cut
d distance

What is claimed is:

1. An attached-type smart label, wherein the smart label is a strip sheet comprising a protective layer formed by flexible plastic paper, an RFID chip layer, a support layer formed by flexible plastic paper, an adhesive layer formed by a base material containing double-sided adhesive film, and a release film layer;
the protective layer and the support layer are attached to two sides of the RFID chip layer, respectively; one surface of the adhesive layer is covered with the release film layer, and the other surface of the adhesive layer is attached to a surface, facing away from the RFID chip layer, of the protective layer or the support layer; and
the RFID chip layer includes an antenna and an RFID chip printed and etched on the base material.

2. The attached-type smart label according to claim 1, wherein a coating provided with a pattern and/or a barcode is arranged on the support layer or the protective layer, and a surface, on which the pattern and/or the barcode is arranged, of the support layer or the protective layer faces away from the RFID chip layer, and the barcode is a 1-dimensional bar code or a QR code, or a combination thereof.

3. The attached-type smart label according to claim 2, wherein a surface of the coating provided with a pattern and/or a barcode is covered with a flexible plastic paper protective film.

4. The attached-type smart label according to claim 1, wherein a shape of the smart label is a quadrilateral, a rounded quadrilateral, or an oval.

5. The attached-type smart label according to claim 1, wherein the smart label is provided with an anti-theft cut, the anti-theft cut penetrates through the protective layer, the RFID chip layer, and the support layer, the anti-theft cut includes cuts respectively extending from four corners and/or edges of the smart label to the center of the smart label, and the cuts are not in contact with the antenna and the RFID chip on the RFID chip layer.

6. The attached-type smart label according to claim 5, wherein the anti-theft cut includes oblique cuts arranged at the four corners and cuts arranged in the middle of two long sides of the smart label, and cuts arranged in the middle of each of the two long sides of the smart label form two shapes like Chinese character “ [symbol] ”, each formed by using two oblique cuts and one straight cut.

7. The attached-type smart label according to claim 1, wherein the smart label is a rectangle or a rounded rectangle with a length of 80-150 mm and a width of 15-40 mm.

8. The attached-type smart label according to claim 2, wherein the smart label is a rectangle or a rounded rectangle with a length of 80-150 mm and a width of 15-40 mm.

9. The attached-type smart label according to claim 3, wherein the smart label is a rectangle or a rounded rectangle with a length of 80-150 mm and a width of 15-40 mm.

10. The attached-type smart label according to claim 4, wherein the smart label is a rectangle or a rounded rectangle with a length of 80-150 mm and a width of 15-40 mm.

11. The attached-type smart label according to claim 5, wherein the smart label is a rectangle or a rounded rectangle with a length of 80-150 mm and a width of 15-40 mm.

12. The attached-type smart label according to claim 6, wherein the smart label is a rectangle or a rounded rectangle with a length of 80-150 mm and a width of 15-40 mm.

13. The attached-type smart label according to claim 1, wherein the smart label is a rectangle or a rounded rectangle with a length of 90-110 mm and a width of 18-26 mm.

14. The attached-type smart label according to claim 2, wherein the smart label is a rectangle or a rounded rectangle with a length of 90-110 mm and a width of 18-26 mm.

15. The attached-type smart label according to claim 3, wherein the smart label is a rectangle or a rounded rectangle with a length of 90-110 mm and a width of 18-26 mm.

16. The attached-type smart label according to claim 4, wherein the smart label is a rectangle or a rounded rectangle with a length of 90-110 mm and a width of 18-26 mm.

17. The attached-type smart label according to claim 5 wherein the smart label is a rectangle or a rounded rectangle with a length of 90-110 mm and a width of 18-26 mm.

18. The attached-type smart label according to claim 6, wherein the smart label is a rectangle or a rounded rectangle with a length of 90-110 mm and a width of 18-26 mm.

19. The attached-type smart label according to claim 13, wherein 6.5 mm long oblique cuts extending obliquely are arranged at four corners and edges of long sides of the smart label, and the oblique cuts penetrate through the protective layer, the RFID chip layer, and the support layer.

20. The attached-type smart label according to claim 19, wherein a 5 mm long straight cut perpendicular to the long side is arranged at a central edge of the long side of the smart label, the straight cut penetrates through the protective layer, the RFID chip layer, and the support layer, and a distance from a starting point of the straight cut on the long side and a starting point of the oblique cut on the long side is 11.7 mm.
